(19) United States
(12) Patent Application Publication
(10) Pub. No.: US 2018/0370502 A1
(43) Pub. Date: Dec. 27, 2018

(54) METHOD AND SYSTEM FOR AUTONOMOUS EMERGENCY SELF-LEARNING BRAKING FOR A VEHICLE

(71) Applicant: Dura Operating, LLC, Auburn Hills, MI (US)

(72) Inventors: Zijian Wang, Royal Oak, MI (US); Robert John Hoffman, JR., Royal Oak, MI (US); Chaodong Gong, Novi, MI (US)

(21) Appl. No.: 15/634,313

(22) Filed: Jun. 27, 2017

(51) Int. Cl. B60T 7/22; G08G 1/16; G05D 1/02; G05D 1/00; G05B 13/02; G06N 3/08; G06N 3/04

(52) U.S. Cl. CPC B60T 7/22; G08G 1/166; G05D 1/0231; G05D 1/0088; B60T 2210/32; G06N 3/08; G06N 3/04; B60T 2201/022; G05B 13/027

(57) ABSTRACT

A method and system for generating a learned braking routine for an autonomous emergency braking (AEB) system. The method includes driving a vehicle; detecting an object in a path of the vehicle or an object moving in a direction toward the path of the vehicle; activating a vehicle brake control to decelerate the vehicle to avoid collision with the object; collecting external information about a surrounding area of the vehicle during a period of time from prior to the detection of the object through the deceleration of the vehicle to avoid collision with the object; collecting vehicle state information during the period of time from prior to the detection of the object through the deceleration of the vehicle to avoid collision with the object; and processing the collected external information and collected vehicle state information through a deep neural network (DNN) to generate an emergency braking routine.

### FIELD

The present disclosure relates generally an emergency braking system, and particularly, to an autonomous emergency braking system.

### BACKGROUND

The statements in this section merely provide background information related to the present disclosure and may or may not constitute prior art.

A motor vehicle brake system typically includes a manually operated brake pedal connected to a master cylinder, which is hydraulically connected to the vehicle brakes. As a mechanical force is applied to the brake pedal by an operator of the vehicle, the master cylinder converts the mechanical force to a proportional amount of hydraulic pressure, which is used to actuate the vehicle brakes to decelerate the vehicle.

Autonomous braking systems are used in motor vehicles to enhance or automate the braking systems of the motor vehicles in order to increase occupant and vehicle safety. Autonomous braking systems include brake controllers that are in communication with external sensors and the vehicle braking systems. The external sensor measures the distance between the vehicle and an object in the path of travel of the vehicle. Once the distance between the vehicle and the object is closing below a predetermined threshold based on the relative velocity of the vehicle and the object, the vehicle controller generates a command signal to activate the braking system to decelerate or stop the vehicle. These autonomous braking systems rely on the objects to be directly in the path of travel of the motor vehicle before a determination can be made whether collision of the objects may be imminent. These braking systems are rule based, which implements a predetermined braking routine that correlates with a predetermined potential collision scenario.

Thus, while current autonomous braking systems achieve their intended purpose, there is a need for a new and improved autonomous braking system and method for autonomous braking to learn braking routines based on the braking behavior of a human driver in reaction to potential collisions with objects, to predict potential collisions with objects not directly in line with the path of travel of the vehicle, and to recognized environmental conditions, such as weather events, that may affect the braking behavior of the braking systems.

### SUMMARY

According to several aspects, a method of generating a learned braking routine for an autonomous emergency braking (AEB) system is disclosed. The method includes the steps of (a) driving a vehicle through an operating environment; (b) detecting an object in a path of the vehicle or an object moving in a direction toward the path of the vehicle; (c) activating a vehicle brake control to decelerate the vehicle to avoid collision with the object; (d) collecting external information about a surrounding area of the vehicle during a period of time from prior to the detection of the object through the deceleration of the vehicle to avoid collision with the object, wherein the surrounding area includes the path of the vehicle and the area where the object is detected; (e) collecting vehicle state information during the period of time from prior to the detection of the object through the deceleration of the vehicle to avoid collision with the object; and (f) processing the collected external information and collected vehicle state information through a deep neural network (DNN) such that the DNN learns to generate a braking routine for instructing an AEB system to decelerate the vehicle in a similar manner as step (c) if a similar object is detected in a similarity manner as step (b).

In an additional aspect of the present disclosure, step (f) further includes the DNN learning to determine the probability of collision and generating the braking routine if the probability of collision is above a predetermined threshold.

In another aspect of the present disclosure, step (f) further includes the DNN learning to assign classifications to objects, wherein the classifications include pedestrians, pedestrian walkways, color of traffic signals, and stop signs. The braking routine includes instructing an AEB system to decelerate the vehicle to a stop if a pedestrian is detected within the pedestrian walkway or if the vehicle has a high probability of driving through a red traffic light or a stop sign.

In another aspect of the present disclosure, the method further includes repeating the steps of (a) through (f), and step (b) includes detecting the object at a different location within the surrounding area of the vehicle each time steps (a) through (f) is repeated.

In another aspect of the present disclosure, step (c) includes depressing a brake pedal to apply a braking force sufficient to decelerate the vehicle to avoid collision with the object, and step (f) includes the DNN generating a braking routine instructing the AEB system to autonomously depress the brake pedal to apply a braking force similar to step (c).

In another aspect of the present disclosure, steps (a) through (c) are performed by a human driver and the operating environment is a closed test track or public roadway.

In another aspect of the present disclosure, the collected external information includes a weather condition, and step (f) includes the DNN generating a braking routine for instructing the AEB system to decelerate the vehicle in a similar manner as step (c) as if a similar object is detected within a similar weather condition.

In another aspect of the present disclosure, the external information is collected by a plurality of external sensors, which includes imaging capturing devices and range detecting devices. The imaging capturing devices include electronic cameras.

In another aspect of the present disclosure, the surrounding area includes the path of travel of the vehicle and sufficient areas to the left and right of the path of travel to detect objects moving toward the path of travel.

According to several aspects, a method of utilizing an artificial neural network (ANN) for an emergency braking (AEB) system is disclosed. The method includes the steps of collecting external information about a surrounding area of a vehicle and vehicle state information about the vehicle; processing the collected external information and collected vehicle state information through the ANN such that the ANN learns to detect objects and generates instructions to activate the AEB system to avoid collisions with the objects. The ANN is a deep neural network (DNN).

In an additional aspect of the present disclosure, the collected external information includes an object in the path of the vehicle or an object moving into the path of the vehicle. The collected vehicle state information includes the transition in vehicle states as the vehicle is decelerated by an operator of the vehicle to avoid collision with the object.

In another aspect of the present disclosure, the DNN learns to generate a braking routine for instructing the AEB system to decelerate the vehicle in a similar manner as by the operator of the vehicle if a similar object is detected in a similar path of the vehicle or similarly moving into the path of the vehicle.

In another aspect of the present disclosure, the DNN learns to determine if collision with the object is imminent without input from the operator of the vehicle and generates instructions to activate the AEB system to avoid collision with the objects if no input is received from the operator.

In another aspect of the present disclosure, the collected external information includes a weather condition. The method further includes the step of the DNN learning to decelerate the vehicle in accordance with the weather condition to avoid collision with the object.

According to several aspects, an active learning autonomous emergency braking system for a vehicle is disclosed. The system includes an external sensor configured to collect external information about a surrounding area of the vehicle; a vehicle state sensor configured to collect information on the state of the vehicle including velocity, acceleration, and braking force applied; an emergency braking routine generator (EBRG) module including a EBRG processor and a EBRG memory device having a deep neural network (DNN) computational model accessible by the EBRG processor; and an autonomous emergency brake (AEB) controller in communication with the EBRG module and a vehicle braking system.

In an additional aspect of the present disclosure, the EBRG processor is configured to process the external sensor information and vehicle state information through the DNN computational model such that the DNN learns to recognize a potential collision with an object in the path of travel of the vehicle or an object moving into the path of travel of the vehicle.

In another aspect of the present disclosure, the EBRG processor is further configured to process the external sensor information and vehicle state information through the DNN computational model such that the DNN learns to generate a braking routine for instructing the AEB system to decelerate the vehicle to void collision with the object if the potential of collision with the object is imminent without an input from a vehicle operator.

In another aspect of the present disclosure, the AEB controller includes an AEB processor and an AEB memory device having predetermined braking routines accessible by the AEB processor.

In another aspect of the present disclosure, the autonomous emergency braking system includes a braking pedal actuatable by the AEB controller to decelerate the motor vehicle.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a functional diagram of an active learning autonomous emergency braking (AEB) system for a motor vehicle according to an exemplary embodiment;

FIG. 2 is schematic illustration of a host vehicle having the autonomous emergency braking system of FIG. 1 in an exemplary operating environment; and

FIG. 3 is a flowchart showing a method of generating a learned braking routine for an autonomous emergency braking (AEB) system

### DETAILED DESCRIPTION

The following description is merely exemplary in nature and is not intended to limit the present disclosure, application, or uses.

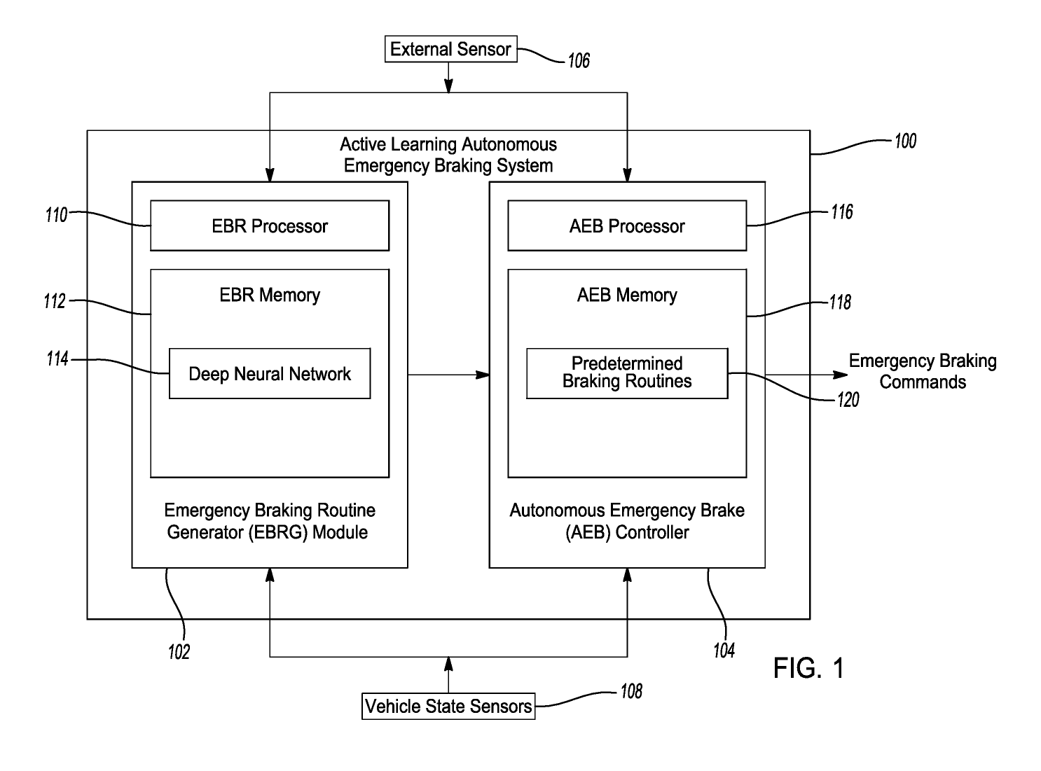

Referring to the drawings, wherein like reference numbers correspond to like or similar components whenever possible throughout the several figures, FIG. 1 shows a functional diagram of an exemplary embodiment of an active learning autonomous emergency braking system 100 (AEB system 100) for a motor vehicle (not shown). The motor vehicle may be that of a land based vehicle such as a passenger car, truck, sport utility vehicle, van, or motor home. The AEB system 100 includes an emergency braking routine generator module 102 (EBRG module 102) and an autonomous emergency braking controller 104 (AEB controller 104). Both the EBRG module 102 and the AEB controller 104 are configured to receive and process information collected by external sensors 106 and vehicle state sensors 108 located on the motor vehicle.

The external sensors 106 are communicatively coupled to the EBRG module 102 and AEB controller 104. The external sensors 106 include a combination of imaging and ranging sensors configured to detect objects in the vicinity of the motor vehicle and to determine the locations of the objects with respect to the motor vehicle. The imaging sensors may include electronic cameras configured to capture markings imprinted or painted onto the surface of a roadway, such as lane markings, and to capture images of both stationary and moving objects, such as traffic signs and pedestrians. The ranging sensors may include radar, laser, sonar, ultra-sonic devices, and the likes. The external sensors may also include Light Detection and Ranging (LiDAR) sensors and scanning lasers that function both as imaging and ranging sensors.

The external sensors 106 may be mounted on an exterior of the vehicle, such as a rotating laser scanner mounted on the roof of the vehicle, or may be mounted within the interior of the vehicle, such as a front camera mounted behind the windshield in the passenger compartment. The external sensors 106 have sufficient sensor ranges to collect information in a coverage area forward of the motor vehicle. The coverage area includes at least the area directly forward of the motor vehicle and sufficient peripheral areas to the left and right of the motor vehicle to detect objects that may enter the projected path of travel of the vehicle.

The information collected by the external sensors 106 may be processed by the EBRG module 102, a separate processor (not shown), and/or an application-specific integrated circuit (ASIC) designed for a specific type of sensor to classify objects as being road markings, traffic signs, pedestrians, infrastructure, etc. It should be appreciated that the ASIC processor may be built into the circuitry of the each of the imaging sensors and ranging sensors. The collected information is also processed to locate the objects by determining the ranges and directions of the objects relative to the vehicle.

The vehicle state sensors 108 may include a speed sensor, a steering angle sensor, inertial measure unit (IMU), etc. communicatively coupled to the EBRG module 102 and AEB controller 104. The vehicle state sensor 108 also include sensors configured to measure the percentage of travel of the brake pedal and the amount of proportional braking force inputted by the brake pedal.

The EBRG module 102 is configured to process information collected by the vehicle external 106 and vehicle state sensors 108 to learn braking patterns based on braking input by a human driver reacting to observed objects in an operating environment. The EBRG module 102 includes an emergency brake routine processor 110 (EBR processor 110) and an emergency brake routine memory device 112 (EBR memory device 112) having an artificial neural network (ANN), such as a deep neural network 114 (DNN 114), accessible by the EBR processor 110. The operating environment may be a controlled closed course vehicle development track or public real-world urban roadway. Based on the learned braking patterns, emergency braking routines are generated by the EBRG module 102 for the AEB controller 104 to intelligently decelerate the vehicle in situations where collision is imminent if no action is taken by the human driver to mitigate the imminent collision.

The ANN includes a set of algorithms, modeled loosely after the human brain, designed to recognize patterns. The ANN interpret sensory data through a kind of machine perception, by labeling or clustering raw input, to enable computers to learn from experience and understand the world in terms of a hierarchy of concepts. The patterns recognize by ANN are numerical, contained in vectors, into which all real-world data, be it images, sound, text or time series, are translated. A detailed teaching of the hierarchy of concepts allowing computers to learn complicated concepts can be found in the text book “Deep Learning”, Adaptive Computation and Machine Learning series, MIT Press, Nov. 18, 2016, by authors Ian Goodfellow, Yoshu Bengio, and Aaron Courville, which is hereby incorporated by reference.

A DNN is an ANN having a plurality of hidden layered networks. Inputs to the DNN are processed through the hidden layers to obtain an output. Each layer trains on a distinct set of features based on the previous layer's output. The output is compared with the correct answer to obtain an error signal, which is then back-propagated to get derivatives for learning. A weighted value is assigned to each input of a set of observed inputs and the weighted values are summed to form a pre-activation. The DNN then transforms the pre-activation using a non-linear activation function (sigmoid) to output a final activation, the percentage of braking value. In one example, the DNN may be based on a Convolution Architecture for Feature Extraction (CAFFE). CAFFE is a deep learning framework developed by the Berkeley Vision and Learning Center (BVLC). The CAFFE offers an open-source library, public reference models, and working examples for deep learning programming.

The emergency braking routines generated by the EBRG module 102 are communicated to the AEB controller 104. The AEB controller 104 is configured to process information collected by the vehicle external sensors 106 and vehicle state sensors 108 for detecting a potential collision of the motor vehicle with an object. If a potential collision is detected, the AEB controller 104 executes an emergency braking routines generated by the EBRG module 102 and/or a predetermined braking routine 120 to generate instructions to the vehicle braking system to decelerate the motor vehicle to avoid or minimize the force of impact of the motor vehicle with the object. The AEB controller 104 includes an autonomous emergency braking (AEB processor 116) and an autonomous emergency braking memory device 118 (AEB memory 118) having predetermined braking routines 120 accessible by the AEB processor 116.

The EBR and AEB processors 110, 116 may be any conventional processor, such as commercially available CPUs, a dedicated ASIC, or other hardware-based processor. The EBR and AEB memory devices 112, 118 may be any computing device readable medium such as hard-drives, solid state memory, ROM, RAM, DVD or any other medium that is capable of storing information that is accessible to the respective EBR and AEB processors 110, 116. Although only one EBRG module 102 and only one AEB controller 104 are shown, it is understood that the vehicle may contain multiple EBRG modules 102 and only AEB controllers 104. Each of the EBRG module 102 and only AEB controller 104 may include more than one processor and memory device, and the plurality of processors and memory devices do not necessary have to be housed within the respective EBRG module 102 and AEB controller 104. Conversely, the EBRG module 102 and AEB controller 104 may share the same processor and memory device.

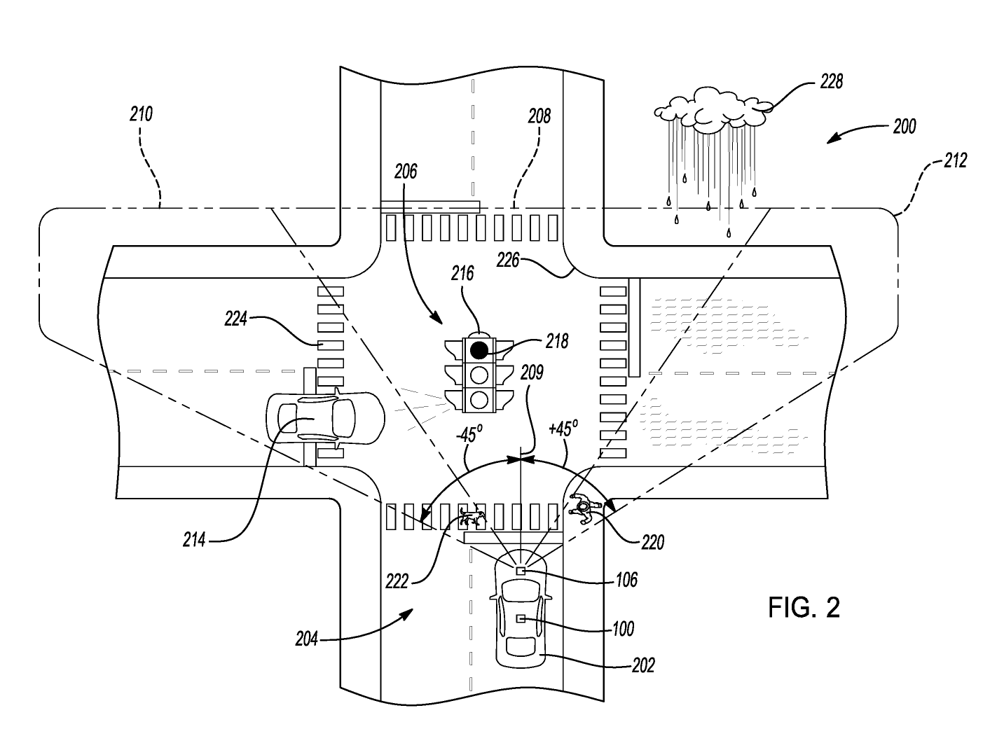

FIG. 2 shows a top view illustration 200 of a host vehicle 202 having the AEB system 100 in an exemplary urban roadway 204 operating environment. The host vehicle 202 is shown traveling along a straight path of travel toward an intersection 206. It is preferable that the external sensors 106 are configured to focus toward the direction of travel of the host vehicle 202, including sufficient peripheral areas to the left 210 and right 212 of the path of travel 209 to detect objects moving toward the path of travel 209. As the host vehicle 202 is moving in the forward direction, the vehicle external sensors 106 are collecting information.

The information collected by the external sensors 106 have an effective coverage area sufficient to detect and locate objects in the path of travel 209 of the host vehicle 202 as well as the areas 210, 212 to at least 45 degrees to the left and right of path of travel 209 of the host vehicle 202. The collected information are fused to consolidate the individual areas 208, 210, 212 of coverage collected by the external sensors 106 and to increase the confidence of the information collected. The fused information is processed to detect and identify the types of objects as well as the distance and locations of the objects relative to the host vehicle 202.

For illustrative purposes only, the consolidated effective fused coverage areas 208, 210, 212 of the external sensors 106 are sufficient to detect the intersection 206 ahead of the host vehicle 202, a remote vehicle 214 heading toward the intersection 206, a traffic light 216 and status 218 of traffic light 216 governing the interaction 206, a pedestrian 220 heading towards the road, and an animal 222 crossing the road. The external sensors 106 may also detect the immediate environment surrounding the host vehicle, including lane markings 224, curbs 226, and weather conditions 228, such as rain or snow that may affect the braking characteristics of the host vehicle 202.

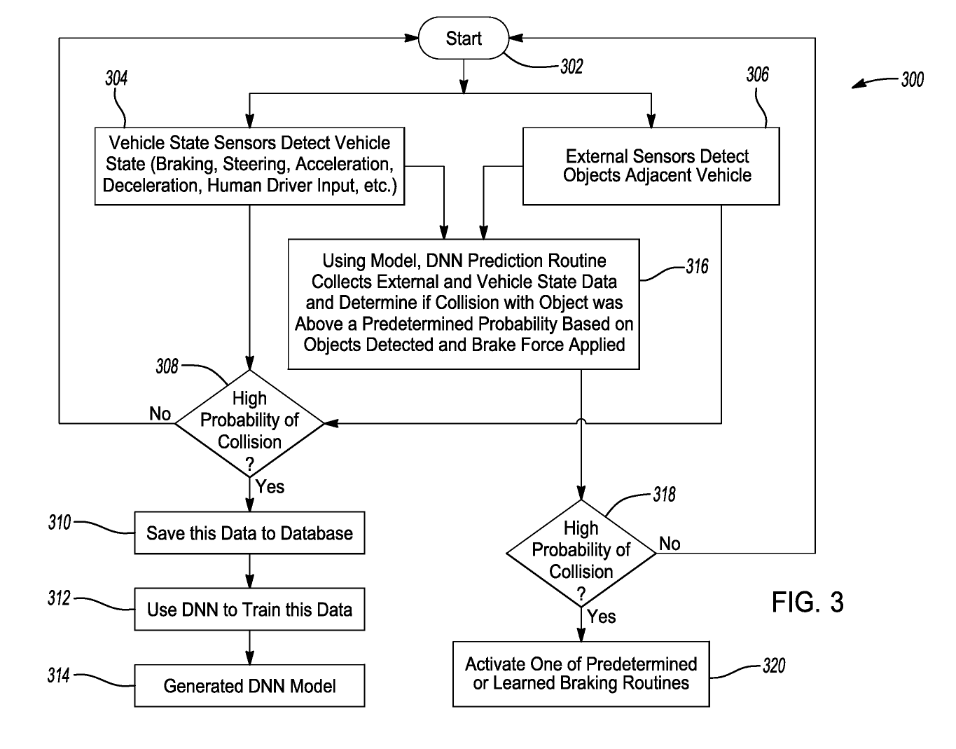

FIG. 3 shows a flowchart 300 of a method of generating and utilizing a learned braking routine generated by an artificial neural network (ANN) for an autonomous emergency braking (AEB) system 100. The method starts in block 302 as the host vehicle 202 is driven in an operating environment, such as a closed test track or a public urban roadway as shown in FIG. 2. In block, 304, the host vehicle state sensors 108 collects vehicle state information including, but not limited to, the velocity of the vehicle, the acceleration of the vehicle, the location of the vehicle, the yaw and pitch of the vehicle, the percentage of depression of the throttle pedal, the percentage of depression of the brake pedal, the amount of braking force applied to the vehicle brakes, etc. In block 306, the external vehicle sensors 106 collects information on the surrounding areas of the vehicle including objects, distances of the objects from the vehicle, the direction of the objects from the vehicle, movement of the objects, and weather conditions such as snow, rain, and/or fog.

In block 308, an ANN, such as a deep neural network (DNN), determines whether the locations and directions of the objects have a probability of colliding with the host vehicle 202 if no action is taken by the human operator, and whether the probability is above a predetermined threshold. If it is above the predetermined threshold, the information collected from the vehicle state sensors 108 and external sensors 106 are saved to the database in block 310. The predetermined threshold may be determined based on the responsiveness of the system 100 and/or degree of risk avoidance.

In block 312, the DNN is trained by the input information to generate the braking routine model in block 314. This braking routine model may be implemented by an AEB controller 104 in block 316 to decelerate the host 202 vehicle to avoid collision with the object if the host vehicle 202 encounters substantially the same circumstances that the DNN was trained on.

In Block 316, the AEB controller 104 collects the information from the vehicle state sensors 108 and external sensors 106. In block 318, the AEB controller 104 utilizes the DNN model generated from block 314 to determine if a potential collision with an object is above a predetermined probability if no action is taken by the human driver. If a potential collision with an object is above a predetermined probability and no action is taken, then in block 320 the AEB controller 104 activates the routine generated by the DNN model or a predetermined routine stored in the AEB memory device 118. If a potential collision with an object is below the predetermined threshold, then the method returns to block 302.

A method and system for autonomous emergency self-learning braking for a motor vehicle of the present disclosure offers several advantages. These include continuously learning braking routines based on the braking behavior of a human driver in reaction to potential collisions with objects, predicating potential collisions with objects not directly in line with the path of travel of the vehicle, and recognizing environmental conditions, such as snow, rain, and/or fog, that may affect the perception and braking behavior of autonomous braking systems.

The description of the present disclosure is merely exemplary in nature and variations that do not depart from the gist of the present disclosure are intended to be within the scope of the present disclosure. Such variations are not to be regarded as a departure from the spirit and scope of the present disclosure.

1. A method of generating a learned braking routine for an autonomous emergency braking (AEB) system, comprising:
(a) driving a vehicle through an operating environment;
(b) detecting an object in a path of the vehicle or an object moving in a direction toward the path of the vehicle;
(c) activating a vehicle brake control to decelerate the vehicle to avoid collision with the object;
(d) collecting external information about a surrounding area of the vehicle during a period of time from prior to the detection of the object through the deceleration of the vehicle to avoid collision with the object, wherein the surrounding area includes the path of the vehicle and the area where the object is detected;
(e) collecting vehicle state information during the period of time from prior to the detection of the object through the deceleration of the vehicle to avoid collision with the object; and
(f) processing the collected external information and collected vehicle state information through a deep neural network (DNN) such that the DNN learns to generate a braking routine for instructing an AEB system to decelerate the vehicle in a similar manner as step (c) if a similar object is detected in a similarity manner as step (b).

2. The method of claim 1, wherein step (f) further includes the DNN learning to determine a probability of collision and generating the braking routine if the probability of collision is above a predetermined threshold.

3. The method of claim 2, wherein step (f) further includes the DNN learning to assign classifications to objects, wherein the classifications include pedestrians, pedestrian walkways, color of traffic signals, and stop signs; and wherein the braking routine includes instructing an AEB system to decelerate the vehicle to a stop if a pedestrian is detected within the pedestrian walkway or if the vehicle has a high probability of driving through a red traffic light or a stop sign.

4. The method of claim 3, further includes repeating the steps of (a) through (f); wherein step (b) includes detecting the object at a different location within the surrounding area of the vehicle.

5. The method of claim 2,
wherein step (c) includes depressing a brake pedal to apply a braking force sufficient to decelerate the vehicle to avoid collision with the object; and
wherein step (f) includes the DNN generating a braking routine instructing the AEB system to autonomously depress the brake pedal to apply a braking force similar to step (c).

6. The method of claim 1, wherein steps (a) through (c) are performed by a human driver; and wherein the operating environment is a closed test track or public roadway.

7. The method of claim 1, wherein the collected external information includes a weather condition, and wherein step (f) includes the DNN generating a braking routine for instructing the AEB system to decelerate the vehicle in a similar manner as step (c) as if a similar object is detected within a similar weather condition.

8. The method of claim 1, wherein the external information is collected by a plurality of external sensors comprising imaging capturing devices and range detecting devices, wherein the imaging capturing devices include electronic cameras.

9. The method of claim 1, wherein the surrounding area includes a projected path of travel of the vehicle and sufficient areas to the left and right of the projected path of travel of the vehicle to detect objects moving toward the projected path of travel of the vehicle.

10. A method of utilizing an artificial neural network (ANN) for an emergency braking (AEB) system, comprising the steps of:
collecting external information about a surrounding area of a vehicle and vehicle state information about the vehicle;
processing the collected external information and collected vehicle state information through the ANN such that the ANN learns to detect objects and generates instructions to activate the AEB system to avoid collisions with the objects.

11. The method of claim 10, wherein the ANN is a deep neural network (DNN).

12. The method of claim 11, wherein the collected external information includes an object in a path of the vehicle or an object moving into the path of the vehicle; and wherein the collected vehicle state information includes a transition in vehicle states as the vehicle is decelerated by an operator of the vehicle to avoid collision with the object.

13. The method of claim 12, wherein the DNN learns to generate a braking routine for instructing the AEB system to decelerate the vehicle in a similar manner as by the operator of the vehicle if a similar object is detected in a similar path of the vehicle or similarly moving into the path of the vehicle.

14. The method of claim 13, wherein the DNN learns to determine if collision with the object is imminent without input from the operator of the vehicle and generates instructions to activate the AEB system to avoid collision with the objects if no input is received from the operator.

15. The method of claim 14, wherein the collected external information includes a weather condition, and further includes the step of the DNN learning to decelerate the vehicle in accordance with the weather condition to avoid collision with the object.

16. (canceled)

17. The system of claim 16, An active learning autonomous emergency braking system for a vehicle, comprising,
an external sensor configured to collect external information about a surrounding area of the vehicle;
a vehicle state sensor configured to collect information on a state of the vehicle including velocity, acceleration, and braking force applied;
an emergency braking routine generator (EBRG) module including a EBRG processor and a EBRG memory device having a deep neural network (DNN) computational model accessible by the EBRG processor; and
an autonomous emergency brake (AEB) controller in communication with the EBRG module and a vehicle braking system.
wherein the EBRG processor is configured to process the external sensor information and vehicle state information through the DNN computational model such that the DNN learns to recognize a potential collision with an object in the a path of travel of the vehicle or an object moving into the path of travel of the vehicle.

18. The system of claim 17, wherein the EBRG processor is further configured to process the external sensor information and vehicle state information through the DNN computational model such that the DNN learns to generate a braking routine for instructing the AEB system to decelerate the vehicle to void collision with the object if the potential of collision with the object is imminent without an input from a vehicle operator.

19. The system of claim 18, wherein in the AEB controller includes an AEB processor and an AEB memory device having predetermined braking routines accessible by the AEB processor.

20. The braking system of claim 18, wherein the autonomous emergency braking system includes a braking pedal actuatable by the AEB controller to decelerate the vehicle.
